(19) United States
(12) Patent Application Publication
(10) Pub. No.: US 2011/0141515 A1
(43) Pub. Date: Jun. 16, 2011

(54) IMAGE FORMING APPARATUS, CONTROL METHOD FOR IMAGE FORMING APPARATUS AND STORAGE MEDIUM

(75) Inventor: Yoshitake Mizuno, Fujisawa-shi (JP)

(73) Assignee: CANON KABUSHIKI KAISHA, Tokyo (JP)

(21) Appl. No.: 12/944,127

(22) Filed: Nov. 11, 2010

(30) Foreign Application Priority Data
Dec. 10, 2009 (JP) 2009-280954

(51) Int. Cl. G06F 15/00

(52) U.S. Cl. 358/1.15

(57) ABSTRACT

The invention provides an image forming apparatus comprising: a combining unit configured to combine an image data and a form image page-by-page; an image forming unit configured to make the image combined by the combining unit to be formed using a print unit for forming the image data and a print unit for forming the form image; an obtaining unit configured to obtain the number of pages of the form image stored in the storage unit; and a determination unit configured to determine whether or not formation of the same number of images as the number of pages of the form image obtained by the obtaining unit has been finished, wherein the image forming unit stops the print unit for forming the form image after the determination unit determines that formation of the same number of images as the number of pages of the form image has been finished.

### BACKGROUND OF THE INVENTION

1. Field of the Invention

The present invention relates to an image forming apparatus, a control method for an image forming apparatus and a program.

2. Description of the Related Art

Conventionally, image forming apparatuses are used that include a developing unit that develops images using four color printing materials such as cyan (C), magenta (M), yellow (Y) and black (Bk). Such image forming apparatuses are used not only for image formation of color documents, but also for image formation of monochrome documents, as well as for image formation of documents in which a color page and a monochrome page are mixed.

There is an image forming apparatus having a mechanism in which, in the case of image formation of a document in which a color page and a monochrome page are mixed, the developing units (C, M, Y and a special toner) that are not used for monochrome image formation are operated during image formation of monochrome images.

However, when the developing units that are not used for monochrome image formation are operated as described above, the service life of the developing units may be shortened more than necessary due to consumption of toner, wear of the developing units and the like. To reduce the consumption of toner and wear of the developing units, an image forming apparatus has been proposed that can switch between a color image formation mode and a monochrome image formation mode. Specifically, when performing image formation of monochrome pages, developing units (C, M and Y) other than the Bk developing unit, are separated from the electrostatic transfer belt, and the operation of the developing units other than the Bk developing unit is stopped. With this, it is possible to prevent the service life of the C, M and Y developing units from being shortened.

However, when changing from the monochrome image formation mode to the color image formation mode or vice versa, for example, operations such as withdrawal and return of the developing units are necessary. For this reason, continuous image formation is not possible when switching between these image formation modes is performed, and it takes time to switch between the image formation modes. For example, when, for each page, image formation of monochrome image data is performed in the monochrome image formation mode and image formation of color image data is performed in the color image formation mode, switching between the image formation modes occurs frequently. Such frequent switching occurs particularly when printing a document in which monochrome image data and color image data are alternately arranged.

To address this, for example, according to Japanese Patent Laid-Open No. 11-34438, when performing image formation of a document in which a color page and a monochrome page are mixed, whether or not to switch the image formation mode is determined based on image data to be subjected to image formation that has been stored in a storage unit.

Specifically, when image data of a page stored in the storage unit is monochrome while operating in the color image formation mode, control is performed such that comparison is made between the time required to perform image formation of the monochrome image in the color image formation mode without changing the mode and the time required to perform image formation of the monochrome image by changing the mode to the monochrome image formation mode. If it is determined that the image formation time will be shorter when image formation is performed in the color image formation mode, image formation is carried out in the color image formation mode without changing the mode.

However, although the conventional method enables switching between the color image formation mode and the monochrome image formation mode, the method cannot switch between image formation modes as appropriate when combining image data with a form image for which a special printing material is used.

For example, there is a case in which the number of pages of a form image for which a special printing material is used is smaller than that of input image data for which image formation is to be performed. In this case, after completion of image formation of a combined image including a form image, if the apparatus is operated in an image formation mode that uses five color units (developing materials, photoconductive drums and the like), the unit corresponding to the special printing material needs to be operated although not used, which causes consumption of toner and wear of the units.

### SUMMARY OF THE INVENTION

The present invention has been conceived to solve the problems encountered with conventional technology.

The present invention provides a technique for achieving both prevention of degradation of the service life of image forming units and improvement of the throughput of image formation processing when combining image data with a form image that uses a special printing material.

According to one aspect of the invention, an image forming apparatus comprises: an input unit configured to receive an input of image data; a storage unit configured to store a form image; a combining unit configured to combine the image data input by the input unit and the form image stored in the storage unit page-by-page; an image forming unit configured to make the image combined by the combining unit to be formed using a print unit for forming the image data and a print unit for forming the form image; an obtaining unit configured to obtain the number of pages of the form image stored in the storage unit; and a determination unit configured to determine whether or not formation of the same number of images as the number of pages of the form image obtained by the obtaining unit has been finished, wherein the image forming unit makes the image to be formed using the print unit for forming the image data and the print unit for forming the form image until the determination unit determines that formation of the same number of images as the number of pages of the form image has been finished; and the image forming unit stops the print unit for forming the form image and makes the image to be formed using the print unit for forming the image data after the determination unit determines that formation of the same number of images as the number of pages of the form image has been finished.

According to the present invention, it is possible to achieve both prevention of degradation of the service life of image forming units and improvement of the throughput of image formation processing when combining image data with a form image that uses a special printing material.

Further features of the present invention will become apparent from the following description of exemplary embodiments with reference to the attached drawings.

### BRIEF DESCRIPTION OF THE DRAWINGS

FIG. 1 is a flow diagram illustrating the flow of image processing performed by a multifunction peripheral according to an embodiment of the present invention.

FIG. 2 is a diagram showing a configuration of the multifunctional peripheral according to the embodiment of the present invention.

FIGS. 3A and 3B are a functional block diagram and a hardware configuration block diagram of a controller.

FIG. 4 is a functional block diagram of a PDL processing unit of the controller.

FIG. 5 is a functional block diagram of a transparent form image processing unit of the controller.

FIG. 6 is a functional block diagram of an image processing unit of the controller.

FIG. 7 is a flowchart illustrating operations of the PDL processing unit.

FIG. 8 is a flowchart illustrating operations of the transparent form image processing unit.

FIG. 9 is a flowchart illustrating operations of the image processing unit.

FIG. 10 is a diagram showing an example of a form image according to the embodiment of the present invention.

FIG. 11 is a diagram showing an example of a printer driver screen displayed on a PC screen.

FIG. 12 is a diagram illustrating print operations performed when an original image and a form image have different numbers of pages.

FIG. 13 is a diagram illustrating operations performed when a blank page is included in a form image or an original image.

FIG. 14 is a diagram illustrating processing for combining image data with a form image according to the embodiment of the present invention.

FIG. 15 is a flowchart illustrating image forming processing performed by the multifunction peripheral according to the embodiment of the present invention.

### DESCRIPTION OF THE EMBODIMENTS

Hereinafter, embodiments of the present invention will be described in detail with reference to the accompanying drawings. It should be understood that the embodiments given below are not intended to limit the scope of the claims of the present invention, and that all combinations of the features described in the embodiments are not necessarily essential to the solving means of the present invention. In the present embodiment, a multifunction peripheral that employs transparent toner is used as an image forming apparatus.

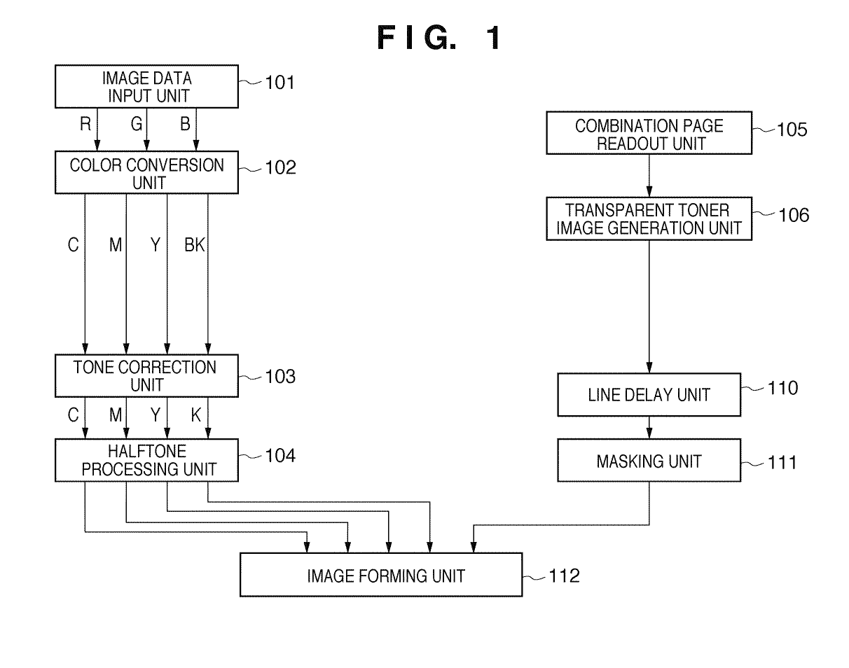

FIG. 1 is a flow diagram illustrating the flow of image processing performed by a multifunction peripheral (image forming control apparatus) according to an embodiment of the present invention.

An image data input unit 101 receives an input of image data to be combined. In the present embodiment, the input image data is assumed to be image data read by an image scanner or image data generated by interpreting a page description language (hereinafter referred to as “PDL”). The image data is assumed to be accumulated on a page-by-page basis and input on a pixel-by-pixel basis. A color conversion unit 102 converts, on a pixel-by-pixel basis, RGB image data to image data of C, M, Y and Bk, which constitutes a color space for printing. A tone correction unit 103 performs tone correction on the CMYBk image data thus generated such that normal tone characteristics are obtained. A halftone processing unit 104 performs, on the image data, for example, pseudo-halftone processing for forming images such as dithering.

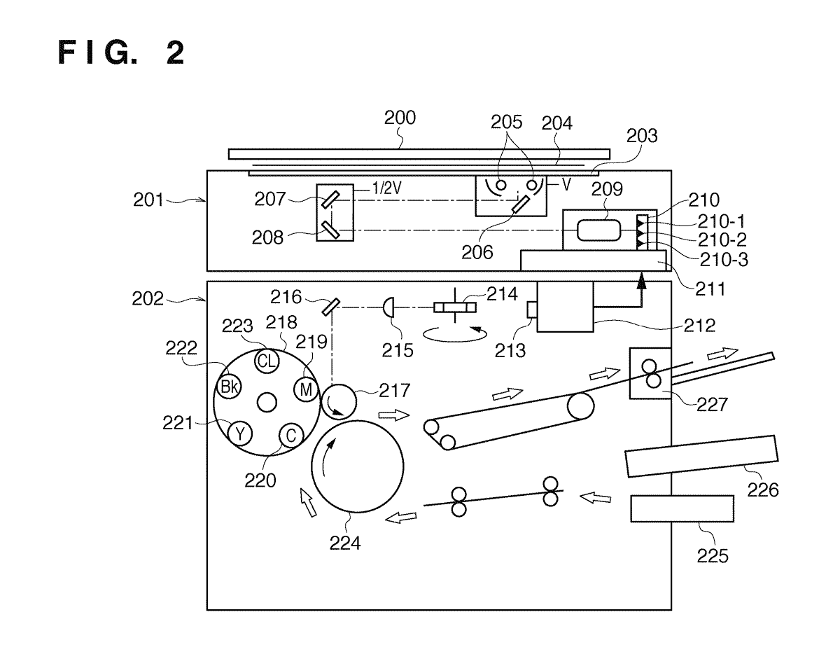

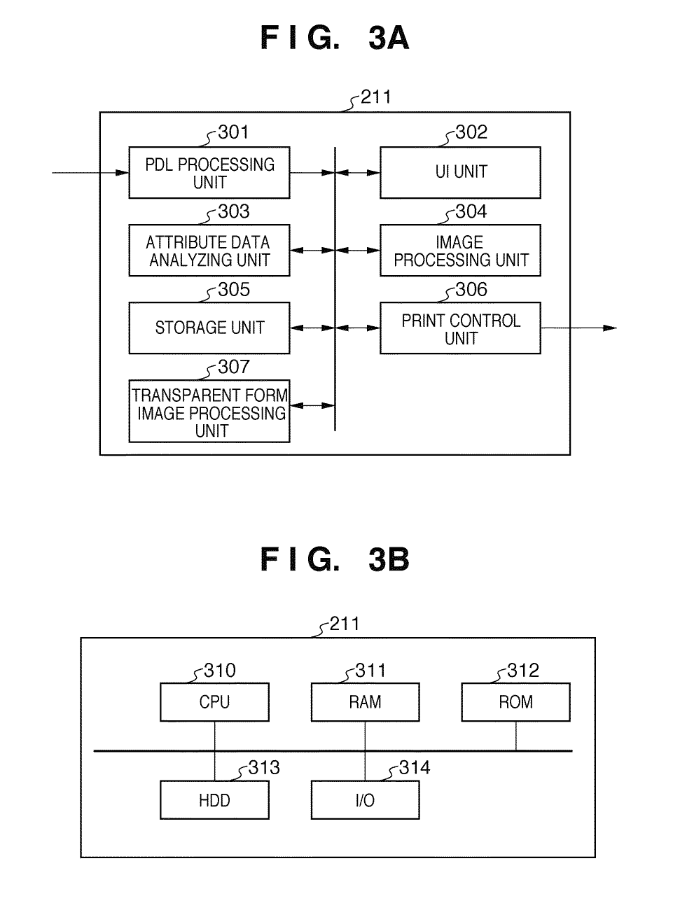

A combination page readout unit 105 reads the image of a corresponding page from among form image data stored in a HDD 313 (FIG. 3B) as a special toner form image. A transparent toner image generation unit 106 generates an image pattern to be printed with transparent toner in the bitmap format based on the image data read by the combination page readout unit 105. The image pattern thus generated is delayed by one line by a line delay unit 110, masked by a masking unit 111, and transmitted to an image forming unit 112. The image forming unit 112 combines the CMYBk full-color image data with the transparent toner image pattern to generate combined image data, and outputs the combined image data to a printer unit 202 (FIG. 2). Here, the image data to be combined is printed using toners (printing materials) for images to be combined such as color toners, and the form image is formed using a toner for form images (transparent toner).

FIG. 2 is a diagram showing a configuration of the multifunctional peripheral according to the present embodiment.

An image scanner unit 201 reads an original, and generates a digital image signal representing an image of the original. The printer unit 202 receives an input of image data corresponding to the image of the original read by the image scanner unit 201, and prints the image data on paper in full color.

A configuration of the image scanner unit 201 will be described next. A mirror surface pressing plate 200 presses and fixes an original 204 on a glass platen 203. The original 204 is irradiated with light by a lamp 205. The reflected light is guided to a lens 209 via mirrors 206 to 208, and formed into an image on a solid-state image sensor (CCD) 210 with three lines. Through this, three image signals, namely, red (R), green (G) and blue (B), are obtained as full-color information, and sent to a controller (signal processing unit) 211. Here, the lamp 205 and the mirror 206 move at speed v and the mirrors 207 and 208 move at speed ½ v, in a direction perpendicular to the electrical scanning (main scanning) direction of the CCD. In this manner, the entire surface of the original 204 is scanned (sub-scanning). At this time, the original 204 is read at a resolution of 600 dpi (dots per inch) in both main and sub-scanning directions. The image data of the original image read in this manner is stored in a data storage unit of the controller 211 on a page-by-page basis. PDL data may be input to the controller 211. The image data that has been input to the controller 211 in this manner is input to the image data input unit 101. The image signals stored inside are electrically processed in units of pixels, decomposed into magenta (M), cyan (C), yellow (Y) and black (Bk) components, and sent to the printer unit 202. The controller 211 includes the combination page readout unit 105 (combination page readout unit 105=readout unit 105), the transparent toner image generation unit 106, the line delay unit 110, the masking unit 111 and the image forming unit 112.

A configuration of the printer unit 202 will be described next.

CMYBk image data and CL image data (transparent toner image data) output from the controller 211 are sent to a laser driver 212. The laser driver 212 modulates/drives a semiconductor laser 213 in accordance with the sent image data. The laser light emitted from the semiconductor laser 213 is thereby scanned over a photoconductive drum 217 via a polygon mirror 214, an f-θ lens 215 and a mirror 216, and an electrostatic latent image according to the image data is formed. The resolution of the image formed here is 600 dpi in both main and sub-scanning directions, as in reading the original. A rotary developing unit 218 includes a magenta developing unit 219, a cyan developing unit 220, a yellow developing unit 221, a black developing unit 222, and a clear (transparent) developing unit 223. In the rotary developing unit 218, the five developing units alternately come into contact with the photoconductive drum 217 and develop the electrostatic latent image formed on the photoconductive drum 217 with toners (printing materials) of respective colors. Paper supplied from a paper cassette 225 or 226 is wrapped around a transfer drum 224, and the transfer drum 224 transfers the image developed on the photoconductive drum 217 to the paper.

The paper to which the five colors M, C, Y, Bk and clear (transparent) have been sequentially transferred in this manner passes through a fixing unit 227. The toners are thereby fixed onto the paper, and thereafter the paper is discharged out of the apparatus. The printer unit 202 switches the image formation mode in accordance with an instruction from a print control unit 306, which will be described later, and performs image formation operations.

The controller 211 will be described next.

FIG. 3A is a functional block diagram showing a functional configuration of the controller 211 according to the present embodiment, and FIG. 3B is a block diagram showing a hardware configuration of the controller 211.

As shown in FIG. 3A, the controller 211 includes a PDL processing unit 301, a UI unit 302, an attribute data analyzing unit 303, an image processing unit 304, a storage unit 305, the print control unit 306, and a transparent form image processing unit 307. The PDL processing unit 301 receives an input of PDL data, analyzes and renders the PDL data. The UI unit 302 controls the user interface of the multifunction peripheral. The attribute data analyzing unit 303 receives attribute data from the PDL processing unit 301 and analyzes the attribute. The image processing unit 304 combines original image data with a form image stored in the storage unit 305, and outputs the resulting image to the print control unit 306. The print control unit 306 generates image data that is output to the printer unit 202, and executes print control. The transparent form image processing unit 307 executes processing for grayscale conversion and binary conversion of form images. The configurations and operations of these units will be described below in detail.

In FIG. 3B, a CPU 310 executes control processing that corresponds to the function of each unit shown in FIG. 3A in accordance with a program stored in a ROM 312. A RAM 311 is used as a work area for temporarily storing various types of data when the CPU 310 executes the program. The HDD 313 is a large capacity storage device that stores transparent toner image data and the like described above, and corresponds to the storage unit 305 shown in FIG. 3A. An I/O 314 is an input/output control unit that controls input and output of data between the CPU 310 of the controller 211 and the outside.

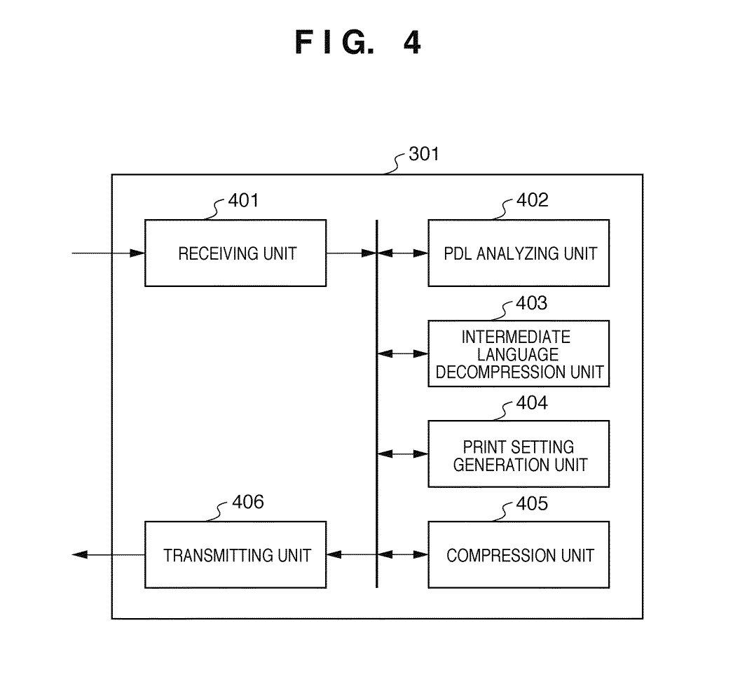

FIG. 4 is a functional block diagram of the PDL processing unit 301 provided in the controller 211.

A receiving unit 401 receives an input of PDL data. A PDL analyzing unit 402 analyzes the input PDL data. An intermediate language decompression unit 403 generates an intermediate language from the PDL data, and performs rendering. A print setting generation unit 404 sets a print mode in the printer unit 202. A compression unit 405 compresses the rendered image data. A transmitting unit 406 outputs the rendered image data to the image processing unit 304 or the like.

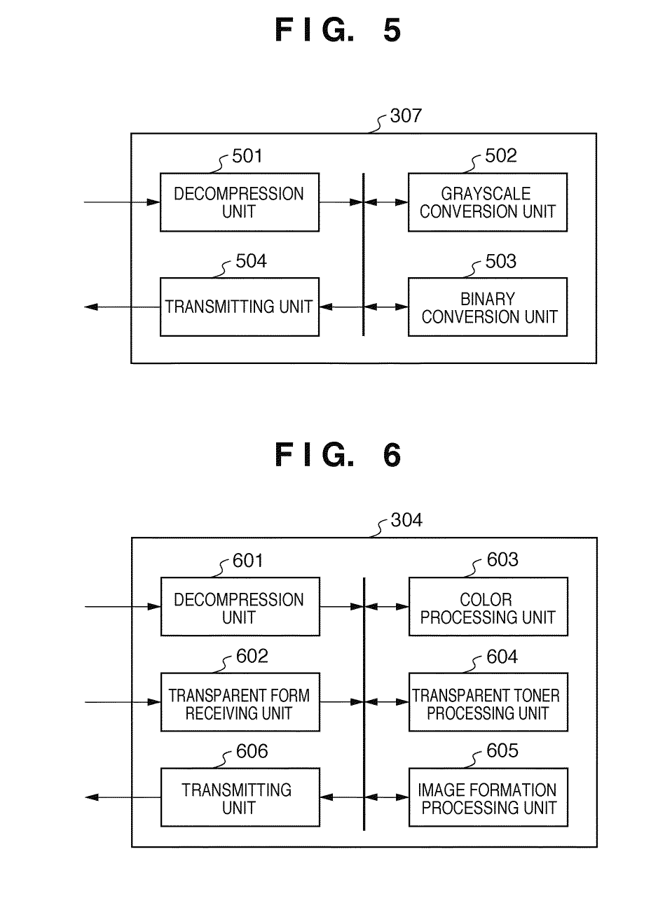

FIG. 5 is a functional block diagram of the transparent form image processing unit 307 provided in the controller 211 according to the present embodiment.

The transparent form image processing unit 307 includes a decompression unit 501, a grayscale conversion unit 502, a binary conversion unit 503, and a transmitting unit 504.

FIG. 6 is a functional block diagram of the image processing unit 304 provided in the controller 211.

The image processing unit 304 includes a decompression unit 601, a transparent form receiving unit 602, a color processing unit 603, a transparent toner processing unit 604, an image formation processing unit 605, and a transmitting unit 606. The transparent toner processing unit 604 outputs form images when printing with transparent toner is performed. In the storage unit 305 of the controller 211, image data that is printed using transparent toner is registered as a form image.

The operation of each unit described above will be described next with reference to flowcharts. In the following description, compression and decompression are assumed to be carried out using a known technique such as JPEG.

An information processing apparatus (PC, not shown) connected to the image forming apparatus of the present embodiment issues an instruction to register a transparent form image as being instructed using a driver UI screen. The PC thereby transmits transparent form image data in the form of PDL data to the multifunction peripheral. The PDL processing unit 301 thereby receives, with the receiving unit 401, the transparent form image data transmitted from the PC.

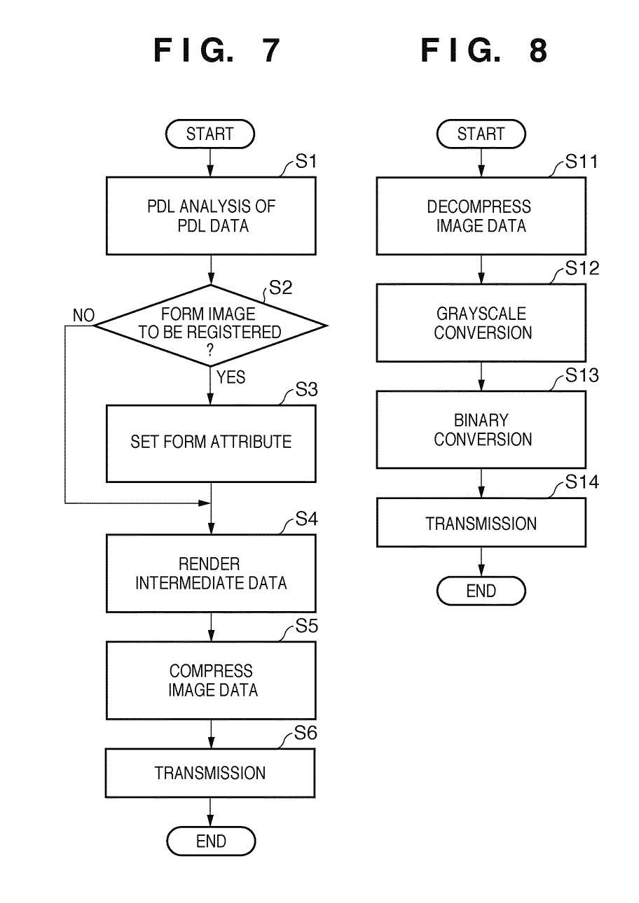

FIG. 7 is a flowchart illustrating operations of the PDL processing unit 301 according to the present embodiment. The program that executes this processing is stored in the ROM 312, and executed under control of the CPU 310.

First, in S1, the PDL analyzing unit 402 analyzes PDL data received from an external PC (information processing apparatus), and generates intermediate data. Next, in S2, it is determined whether or not the PDL data analyzed in S1 is a form image to be registered as a form image. Whether or not the PDL data is a form image to be registered as a form image is set by the external PC. If it is determined in this step that the PDL data is a form image to be registered, control advances to S3, where a form attribute indicating that the PDL data is to be registered as a form image is set in the image data. If, on the other hand, it is determined in S2 that the PDL data is not a form image to be registered, control skips S3 and advances to S4. If S3 is skipped, ordinary image attribute is set. In S4, the intermediate language decompression unit 403 renders the intermediate data generated in S1, and generates image data. Next, in S5, the compression unit 405 compresses the image data, and generates compressed data. Next, in S6, the transmitting unit 406 transmits the set attribute data to the attribute data analyzing unit 303. The transmitting unit 406 also transmits the compressed data to the decompression unit 501 of the transparent form image processing unit 307.

FIG. 8 is a flowchart illustrating operations of the transparent form image processing unit 307 according to the present embodiment. The program that executes this processing is stored in the ROM 312, and executed under control of the CPU 310.

First, in S11, the decompression unit 501 decompresses received compressed data. Next, in S12, the grayscale conversion unit 502 converts the decompressed image data to grayscale data. As an example of the conversion method, it is possible to, when an RGB signal has been input, convert the RGB signal to a YUV signal and use only a Y signal as a grayscale signal, but the present invention is not limited thereto. Next, in S13, the binary conversion unit 503 converts the image signal converted to grayscale data to binary image data. As an example of the conversion method, a threshold value is set. Binary image data is generated by setting the pixel value to “1” if the grayscale signal value is larger than the threshold value and setting the pixel value to “0” if the grayscale signal value is smaller than the threshold value. Next, in S14, the transmitting unit 504 transmits the binary image data to the storage unit 305 for storage in the HDD 313. The storage unit 305 thereby receives the binary image data and saves the data as a form image.

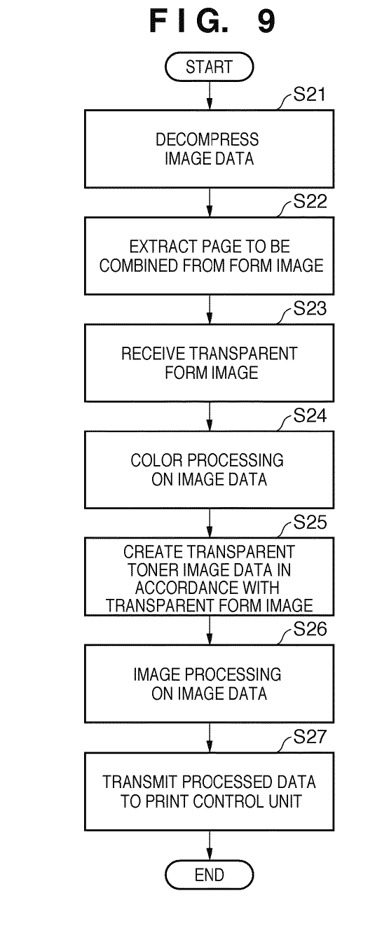

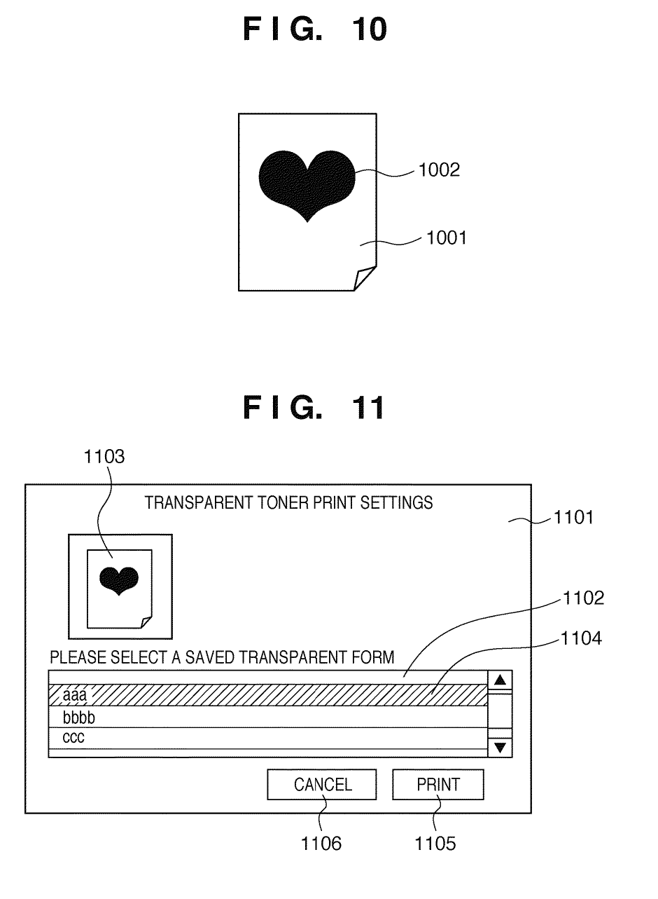

FIG. 9 is a flowchart illustrating operations of the image processing unit 304 according to the present embodiment. The program that executes this processing is stored in the ROM 312, and executed under control of the CPU 310.

First, in S21, received image data is decompressed by the decompression unit 601. Next, in S22, the image of a corresponding page to be combined is extracted as transparent form page image data that is to be combined with original image data (image data received from an external apparatus or image data read with the scanner). Next, in S23, the transparent form receiving unit 602 receives the form image from the storage unit 305. Then, in S24, if the image data is RGB image data, the color processing unit 603 converts the image data to CMYBk image data, and adjusts the density by computational processing or the like. If the image data is CMYBk image data, the color processing unit 603 adjusts the density by computational processing or the like. Next, in S25, the transparent toner processing unit 604 performs ordinary print processing for an area whose pixel value is “1” in the form image, or in other words, the binary image, thereby determining the amount of transparent toner, and does nothing for an area whose pixel value is “0” in the binary image. In this manner, the transparent toner processing unit 604 generates image data that includes the amount of transparent toner. Next, in S26, the image formation processing unit 605 performs image processing for forming an image by performing, on each version (C, M, Y, Bk and transparent color), gamma correction processing set by the image forming apparatus. This image processing uses a screen and error diffusion. Then, in S27, the transmitting unit 606 transmits the image-processed image data to the print control unit 306.

The print control unit 306 of the controller 211 thereby selects an image formation mode in accordance with the color mode of the form image and the color mode of the original image. Then, the print control unit 306 notifies the printer unit 202 of various types of operation modes and various types of settings such as the type of paper, and the image data is transmitted and printed.

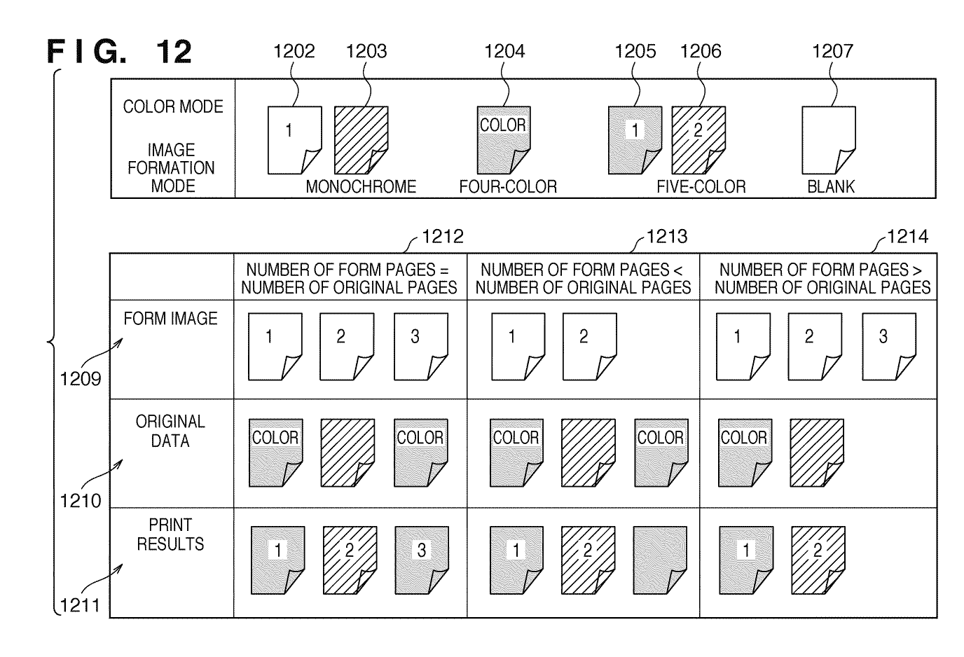

FIG. 10 is a diagram showing an example of a form image according to the present embodiment. FIG. 11 is a diagram showing an example of a printer driver screen displayed on a PC screen according to the present embodiment.

A form image 1001 shown in FIG. 10 is binary image data, and 1002 indicates a region whose pixel data is “1”. In this region, image formation using transparent toner is performed to provide a visual effect created by the transparent toner.

Referring to FIG. 11, on a PC screen 1101, a transparent form image list 1102, a preview display screen 1103, a cancellation button 1106, and a print button 1105 are displayed. If, for example, a transparent form image “aaa” 1104 is selected with the cursor, the first page of the transparent form image 1104 is displayed on the preview display screen 1103. In this state, if the print button 1105 is selected, printing is performed using the selected transparent form image 1104. If the cancellation button 1106 is selected, this print setting operation is canceled.

Next, print processing using transparent toner will be described. As described earlier, form images have been registered in the storage unit 305. The user can select a form image he/she wants to combine with an original image and issue an instruction to perform combination printing on the screen shown in FIG. 11. In other words, when an instruction to perform printing using a transparent form image is issued, the printer driver of the PC displays the screen shown in FIG. 11 on the PC screen. If a transparent form image to be used for printing is selected from among a large number of saved transparent form images, the printer driver UI displays the preview display screen 1103 showing the image of the first page on the screen. Then, in response to a print instruction issued with the print button 1105, the PC transmits PDL data generated with the printer driver to the multifunction peripheral.

The receiving unit 401 provided in the PDL processing unit 301 receives the PDL data of the image to be printed from the PC. The processing procedure performed by the PDL processing unit 301 at this time is substantially the same as that performed when registering a transparent form image shown in FIG. 7. The difference from the flowchart of FIG. 7 is that S3 is skipped.

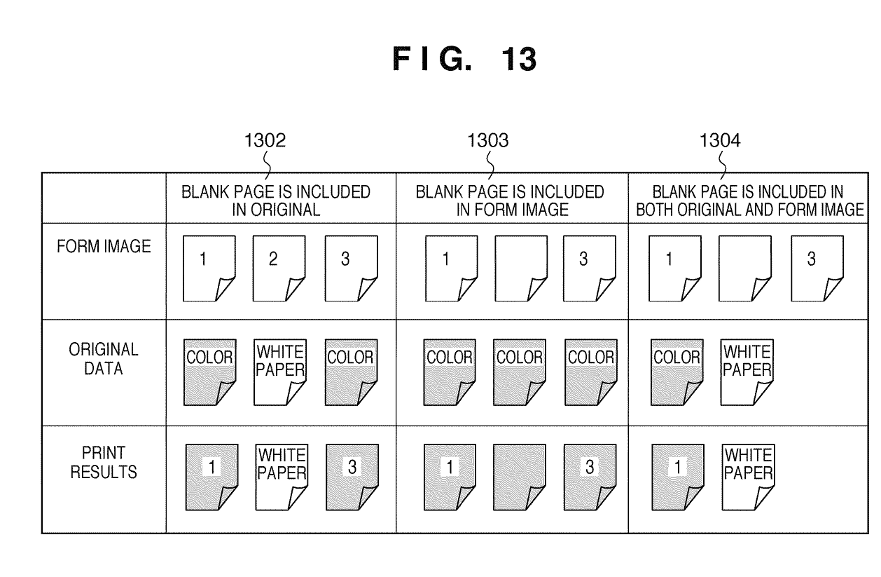

FIG. 12 is a diagram illustrating print operations according to the number of pages of an original image and the number of pages of a form image. When performing printing by combining image data with a form image, the pages of the form image and the pages of the original image are brought into one-to-one correspondence, combined and printed.

FIG. 12 shows a diagram illustrating a color mode and an image formation mode.

Reference numeral 1202 indicates an original in which the number “1” has been written, or a page in which the number “1” has been printed, in black on a white paper sheet. Reference numeral 1203 indicates a monochrome original, or a page printed in monochrome. Reference numeral 1204 indicates a color original, or a page printed in full color. Reference numeral 1205 indicates a page in which the number “1” has been printed on a full-color image using a special color toner such as transparent toner. Reference numeral 1206 indicates a page in which the number “2” has been printed on a monochrome image using a special color toner such as transparent toner. Reference numerals 1205 and 1206 indicate a five-color image formation mode where printing is performed by combining a special color toner such as transparent toner with another toner. Reference numeral 1207 indicates a blank original, a page that has been output without image formation, or an image formation mode where only paper passes through without print operation. Here, a configuration where, in the case of image formation by combining black toner and the special color toner, image formation is performed in a five-color mode in which developing units such as yellow, magenta and cyan are also operated is explained as an example.

FIG. 12 also shows a diagram illustrating the relationship between the number of pages registered as a transparent form image and the number of pages included in an original document to be combined with the transparent form image and printed.

Reference numeral 1209 indicates pages included in a form image. Reference numeral 1210 indicates pages included in an original document. Reference numeral 1211 indicates print results obtained by combining a transparent form image and an original document and printing them. Reference numeral 1212 indicates the case where the number of pages included in a form image and the number of pages of an original document are equal. Here, three pages of transparent form images in which a number has been written in monochrome and three pages of original images arranged in the order of color, monochrome and color are combined. Thus, three pages of print results are obtained in which the first and third form images have been combined with the first and third color images using transparent toner, and the second form image has been combined with the second monochrome image using transparent toner.

Reference numeral 1213 indicates the case where the number of pages included in an original document is larger than the number of pages included in a form image. Here, two pages of form images in which a number has been written in black and three pages of original images arranged in the order of color, monochrome and color are combined. In this case, the first form image is combined with the first color image using transparent toner, the second form image is combined with the second monochrome image using transparent toner, and the third color image is printed as it is.

Reference 1214 indicates the case where the number of pages included in a form image is larger than the number of pages included in an original document. Here, three pages of form images in which a number has been written in black and two pages of original images arranged in the order of color and monochrome are combined. In this case, two pages of print results are obtained in which the first form image has been combined with the first color image using transparent toner, and the second form image has been combined with the second monochrome image using transparent toner.

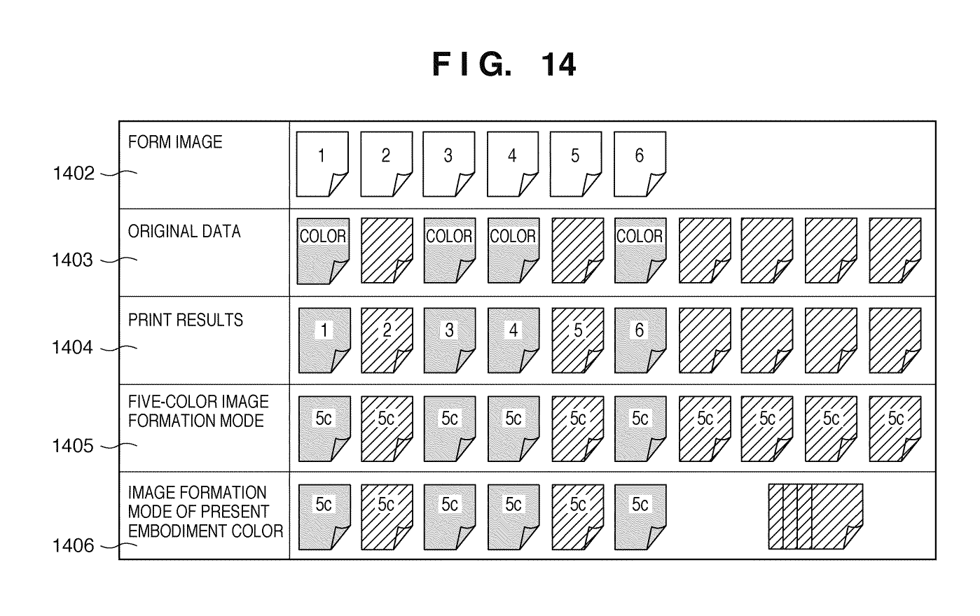

Next, operations performed when a blank page is included in a form image or an original image will be described with reference to FIG. 13.

Reference numeral 1302 indicates an example in which a blank page is included in an original document. Here, it is assumed that when original images are blank, form images are not combined with them. In this example, three pages of form images in which a number has been written in black and three pages of original images arranged in the order of color, blank and color are combined. In this case, a total of three pages of print results are obtained in which the first and third form images have been combined with the first and third color pages of the original image using transparent toner, but the second page of the original image that is blank has remained as it is.

Next, 1303 indicates a case in which a blank page is included in a form image. In this example, three pages of form images with the first and third pages having the number written in monochrome and the second page being blank and three pages of full-color original images are combined. In this case, a total of three pages of print results are obtained in which the first and third form images have been combined with the first and third color pages of the original image using transparent toner, and the second page of the original image has been printed as it is.

Reference numeral 1304 indicates an example in which a blank page is included in both a form image and an original document. In this example, the first and third pages of form images have a number in monochrome, and the second page is blank. The original includes two pages of original images with the first page being color and the second page being blank. In this case, the first form image is combined with the first color page of the original image using transparent toner, and the second page of the original image that is blank remains as it is.

Next, combination operations according to the present embodiment will be described.

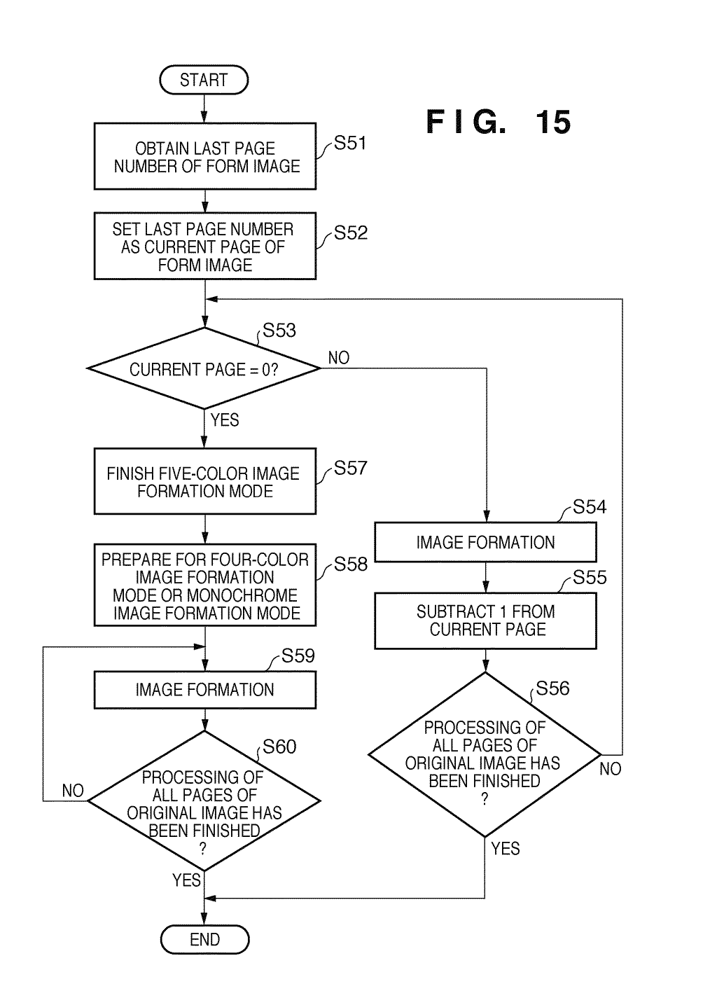

FIG. 14 is a diagram illustrating processing for combining image data with a form image according to the present embodiment. Here, a case will be described in which six pages of a form image and ten pages of an original document are combined.

Reference numeral 1402 indicates a form image including six pages in which a number has been written. Reference numeral 1403 indicates original image data including ten pages with the first page being color, the second page being monochrome, the third and fourth pages being color, the fifth page being monochrome, the sixth page being color, and the seventh to tenth pages being monochrome. Reference numeral 1404 indicates images resulting from combining the original images 1403 with the form images 1402. In this example, the first to sixth pages of the original image are combined with the first to sixth pages of the form image of a special color (transparent toner), and the remaining four pages of the original image are printed in monochrome.

Reference numeral 1405 indicates images obtained when all ten pages of the original image have been printed in a five-color image formation mode, and the horizontal axis corresponds to elapsed time. In this case, because all of the printed pages have been printed in the five-color image formation mode, the time required to print each page is the same, and the time required to switch the image formation mode is “0”. Reference numeral 1406 indicates an illustration of an image formation mode in the case of operation by an image formation switching method according to the present embodiment, and the horizontal axis corresponds to elapsed time. In this case, the first to sixth pages of the original image are printed in the five-color image formation mode, and the remaining four pages are printed in a monochrome image formation mode.

In this case, the mode is switched from the five-color image formation mode to the monochrome image formation mode after the sixth page of the original image has been printed, so it takes time to switch the mode. However, the print time per page is shorter in the monochrome image formation mode. Accordingly, the print time can be made shorter than when all ten pages of the original image are printed in the five-color image formation mode.

In addition, the timing of switching of the image formation mode can be determined based on the number of pages of form images stored. For this reason, when original image data is received PDL data, the timing of switching of the image formation mode can be appropriately determined without waiting for finishing of analysis, decompression, storage and calculation of the timing of switching from the stored original image data. When original image data is image data read by the scanner, the timing of switching of the image formation mode can be appropriately determined without waiting for finishing of storage and calculation of the timing of switching from the stored original image data.

Next, image formation mode switching processing performed by the multifunction peripheral according to the present embodiment will be described.

FIG. 15 is a flowchart illustrating image formation processing performed by the multifunction peripheral of the present embodiment, and the program that executes this processing is stored in the ROM 312, and executed under control of the CPU 310.

This processing starts when the user inputs a job to print a combined image from a form image and an original from a PC by means of the UI screen shown in FIG. 11.

The CPU 310 stores image data input by the image data input unit 101 in the storage unit 305, performs image processing that is necessary to form images on the image data, and thereafter starts an image formation operation.

First, in S51, the CPU 310 obtains the last page number of a form image selected to be combined that is stored in the storage unit 305. The CPU 310 identifies how many pages of the form image will be used based on the last page number.

Next, in S52, the CPU 310 records the current page value in the RAM 311 in order to count the number of pages of the form image to be combined. As the current page value, the last page number obtained in S51 is set.

Next, in S53, the CPU 310 determines whether the current page value is “0”. If the current page value is not “0”, control advances to S54, where the CPU 310 causes the image forming unit 112 to perform image formation. Then, control advances to S55, where the CPU 310 subtracts 1 from the current page value, and control advances to S56. In S56, the CPU 310 judges whether all of the pages of the original image have been printed. If all of the pages of the original image have not been printed, control returns to S53. If it is judged in S56 that all of the pages of the original image have been printed, the CPU 310 finishes the processing.

If, on the other hand, the CPU 310 has judged in S53 that the current page value is “0”, control advances to S57, where the print control unit 306 finishes the five-color image formation mode before image formation of the next page. The CPU 310 transmits an engine stop signal to the image forming unit 112 to temporarily stop the image formation operation. Then, in S58, the CPU 310 starts preparing for an ordinary four-color image formation mode. In response thereto, the CL toner developing unit is separated from the transfer drum 224, and the image formation mode in which image formation is performed using five color developing units is switched to an image formation mode in which image formation is performed using four color developing units.

Next, in S59, the CPU 310 performs image formation using the four color developing units. Then, in S60, the CPU 310 checks whether the image formation processing of the original image has been finished. If the image formation processing has not been finished, control advances to S59, where subsequent image formation is executed.

If the input original image data is monochrome and image formation has been performed in monochrome, in S58, the CPU 310 starts preparing for an ordinary monochrome image formation mode. In response thereto, the CL toner developing unit is separated from the transfer drum 224, and the image formation mode in which image formation is performed using two color developing units (Bk toner and CL toner) is switched to an image formation mode in which image formation is performed using only the Bk toner developing unit.

If the last page of the form image is blank, in S52, a value obtained by subtracting the number of pages at the end of the form image that are blank, from the page number of the last page of the form image, may be set as the current page value.

The above embodiment has been described using an example in which a form image is combined with continuous original data. In such a case, the number of pages of the form image is obtained, and the timing of switching of the image formation mode is determined according to the obtained number of pages. However, the present invention is not limited thereto. A form image may be designated and registered so as to be combined with a specified page of original data. In such a case, it is possible to employ a configuration in which the CPU 310 identifies which page is combined with the form image in accordance with pre-stored form image data. Then, the CPU 310 determines the page number before which switching of the image formation mode is to be executed in order to increase the throughput in accordance with the identified information. The CPU 310 can switch the image formation mode at the determined timing.

### Other Embodiments

Aspects of the present invention can also be realized by a computer of a system or apparatus (or devices such as a CPU or MPU) that reads out and executes a program recorded on a memory device to perform the functions of the above-described embodiments, and by a method, the steps of which are performed by a computer of a system or apparatus by, for example, reading out and executing a program recorded on a memory device to perform the functions of the above-described embodiments. For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2009-280954, filed on Dec. 10, 2009, which is hereby incorporated by reference herein in its entirety.

What is claimed is:

1. An image forming apparatus comprising:
an input unit configured to receive an input of image data;
a storage unit configured to store a form image;
a combining unit configured to combine the image data input by the input unit and the form image stored in the storage unit page-by-page;
an image forming unit configured to make the image combined by the combining unit to be formed using a print unit for forming the image data and a print unit for forming the form image;
an obtaining unit configured to obtain the number of pages of the form image stored in the storage unit; and
a determination unit configured to determine whether or not formation of the same number of images as the number of pages of the form image obtained by the obtaining unit has been finished,
wherein the image forming unit makes the image to be formed using the print unit for forming the image data and the print unit for forming the form image until the determination unit determines that formation of the same number of images as the number of pages of the form image has been finished; and
the image forming unit stops the print unit for forming the form image and makes the image to be formed using the print unit for forming the image data after the determination unit determines that formation of the same number of images as the number of pages of the form image has been finished.

2. The image forming apparatus according to claim 1,
wherein a printing material that records the form image is transparent toner.

3. A control method for an image forming apparatus comprising a storage unit configured to store a form image, comprising the steps of:
receiving image data;
combining the received image data and the form image stored in the storage unit page-by-page;
making the image combined in the combining step to be formed using a print unit for forming the image data and a print unit for forming the form image;
obtaining the number of pages of the form image stored in the storage unit; and
determining whether or not formation of the same number of images as the number of pages of the form image obtained in the obtaining step has been finished,
wherein the image is made to be formed using the print unit for forming the image data and the print unit for forming the form image until it is determined in the determining step that formation of the same number of images as the number of pages of the form image has been finished; and
the print unit for forming the form image is stepped and the image is made to be formed using the print unit for forming the image data after it is determined in the determining step that formation of the same number of images as the number of pages of the form image has been finished.

4. A computer readable storage medium storing a program for causing a computer to execute the control method according to claim 3.
